(19) United States
(12) Patent Application Publication
(10) Pub. No.: US 2005/0118341 A1
(43) Pub. Date: Jun. 2, 2005

(54) Rolled product and corresponding production process

(76) Inventor: Roberto Lanata, Genova (IT)

Correspondence Address: SUGHRUE MION, PLLC, 2100 PENNSYLVANIA AVENUE, N.W., SUITE 800, WASHINGTON, DC, 20037, US

(21) Appl. No.: 10/778,238

(22) Filed: Feb. 17, 2004

(30) Foreign Application Priority Data
Feb. 18, 2003 (IT) TO2003A000120

(51) Int. Cl. B05D 3/02; B32B 15/08

(52) U.S. Cl. 427/372.2; 428/626; 428/648; 427/402; 427/299

(57) ABSTRACT

The rolled product comprises: a base layer of steel having a carbon content of between 0.10 and 0.20% and chromium- and/or tin-plated on both surfaces, an anticorrosion layer applied to at least one of the surfaces of the base layer and a transparent layer coating the anticorrosion layer. This coating layer comprises a paint of the polyester and/or polyurethane and/or acrylic type. The corresponding production process comprises the stages of: mechanically brushing a strip of chromium- and/or tin-plated steel, applying the anticorrosion layer to at least one surface of the strip of chromium- and/or tin-plated steel and applying the transparent layer comprising the paint, and drying the anticorrosion layer and the paint.

This invention relates to a metal-based rolled product and corresponding production process.

By way of a non-limiting example, rolled products of this type may find application in the outer housings of electrical domestic appliances, for example doors and walls constituting the outer body of refrigerators, washing machines, dishwashers, chest or vertical freezers, refrigerated display cases and chests, cookers and stoves, extraction hoods and other worktop electrical domestic appliances for home and community use.

The rolled products conventionally used for these objects are made from a base of stainless steel, that is a decidedly expensive noble material.

The purpose of this invention is to provide a rolled product which although having aesthetic properties comparable to those of known rolled products is of lower cost.

According to the invention this object is achieved through a rolled product comprising a base layer of steel having a carbon content of between 0.10 and 0.20% and chromium- and/or tin-plated on both surfaces, an anticorrosion layer applied to at least one of the surfaces of the base layer and a transparent layer coating the anticorrosion layer, the said coating layer comprising a paint of the polyester and/or polyurethane and/or acrylic type.

The combination of a chromium- and/or tin-plated low carbon content steel base layer and a layer having anticorrosion properties—materials which are definitely “poor” compared to stainless steel—makes it possible to obtain satisfactory resistance to atmospheric agents and oxidising agents.

The anticorrosion layer may be of any conventional type which also has film-forming properties, so as to favour subsequent application of the coating layer. Mention may be made by way of example of Gardobond PC 8901 A and B from the company Chemetall, which comprises a system of water-soluble acrylic copolymers in combination with a solution containing chromate ions.

The paint used for the transparent layer may be liquid or powder and is manufactured from a base of polyester and/or polyurethane and/or acrylic resins, preferably present in a percentage varying between 40 and 60% of the solid residue in the paint. The various resins are caused to react in the required proportions for example to optimise the properties which allow them to be used in the production line process—such as applicability, spreading, adhesion and cross-linking—and those of the dry film—such as flexibility, surface hardness, resistance to abrasion and solvents. Chemical reaction between the different resins is encouraged through the use of a catalyst which may be an organic acid or a metal salt.

The transparent coating layer heightens the aesthetic properties of the rolled material and because of the properties of its constituents at the same time prevents the formation of marks and may be screen printed. The latter property is particularly useful for the components of electric domestic appliances, on which it is frequently necessary to apply use or safety instructions or text advertising the manufacturer.

Advantageously the paint used for the coating layer does not include the presence of toxic components and is provided with a certificate of suitability for accidental contact with foodstuffs.

Preferably the chromium plating on each surface of the base layer comprises a first sublayer of metal chromium having an average mass of between 50 and 150 mg/m² and a second sublayer of chromium oxide having an average mass of between 7 and 35 mg/m².

Preferably the layer of tin plating on each surface of the base layer has a mass per unit surface area of between 1 and 11.2 g/m². The mass per unit surface area values for the layer of tin plating on each surface of the base layer may be the same or different.

In a preferred embodiment of the rolled product according to the invention, the base layer has a thickness of between 0.30 and 0.60 mm, the anticorrosion layer has a thickness of between 1 and 2 μm, and the coating layer has a thickness of between 7 and 10 μm.

Again preferably, the base layer is of steel having a carbon content of approximately 0.13%.

In order to further improve the oxidation resistance of the rolled product according to the invention a film of PET may be applied to the outer surface of the coating layer. Advantageously, this film will have a thickness of between 15 and 20 μm and will be applied during the stage in which the paint of the coating layer is dried out through a “co-rolling” process.

A further subject of this invention is constituted by a process for the production of a rolled product of the type indicated above comprising the stages of:
mechanically brushing a strip of chromium- and/or tin-plated steel,
applying an anticorrosion layer having film-forming properties to at least one surface of the strip of chromium- and/or tin-plated steel and then applying a transparent coating layer comprising a paint of the polyester and/or polyurethane and/or acrylic type, and
drying the anticorrosion layer and the paint.

Further features and advantages of this invention will be apparent from the following embodiment provided by way of a non-limiting example.

### EXAMPLE

The starting material for obtaining the base layer for the rolled product is a strip of steel of thickness approximately 0.50 mm, cold rolled with a carbon content of 0.13%. The metal rolled through simple reduction has a hardness of between 51 and 64 Rockwell 30 Tm. and is subsequently work hardened through annealing in a protective atmosphere.

Then the two surfaces of the strip are chromium plated using a continuous electrodeposition process. The chromium plating on each surface comprises a first sublayer of metal chromium having an average mass of 100 mg/m² and a second sublayer of chromium oxide having an average mass of 21 mg/m².

The finish used is the “bright” finish obtained during rolling through the use of rolls which have been subjected to fine straightening in the work hardening train.

The strip is subsequently subjected to mechanical brushing on a continuous line which uses rotating and vibrating brushes to confer the characteristic satin appearance of the SCOTCH BRIGHT type on the metal. The brushes used are preferably of aluminium oxide or silicon dioxide, which confer a more natural metal appearance upon the treated strip. This processing makes it possible to obtain a pleasing satin appearance, reduce the brightness of the metal and mask small imperfections which might be visually detectable in the bright state. The speed of the brushing process is approximately 6-8 metres per minute depending upon the equipment used. In the course of the process the material undergoes abrasion with a minimum removal of the metal of the order of approximately 1.7 μm of metal.

Once unrolled from a reel and drawn by a system of drafting bridles the strip then passes through a zone in which it is washed with an alkaline degreasing agent and a subsequent zone of rinsing with water, with provision for the use of a system with several phases in cascade, the last of which uses demineralised water.

An anticorrosion layer is then applied to one surface of the strip. This application may take place through applicator rollers, or by spraying, or again by immersion and subsequent wiping.

The anticorrosion layer comprises a two-component system comprising the components “A” and “B”, in which component “A” comprises an acrylic copolymer emulsion in acid phase stabilised with a trivalent chromium salt, while component “B” contains chromates, phosphoric acid and zinc oxide (5-10% chromium trioxide, 5-10% zinc phosphate, 5-10% zinc chromate). The two components are mixed together before application in a ratio equal to 3 parts of component “A” and 1 part of component “B” in order to form a homogeneous liquid. The solution so obtained may be diluted with demineralised water according to the application.

The anticorrosion layer is dried in a continuous stove with a peak metal temperature lying between 60 and 120° C. During the stove drying a base layer of chromium phosphate and zinc phosphate forms and guarantees appreciable resistance to corrosion on the part of the material so treated. In addition to this the acrylic resin present in the layer appreciably improves the corrosion resistance of the rolled product once it has been polymerised and encourages adhesion of the subsequent coating layer.

The anticorrosion layer, which has a thickness of approximately 2 μm, increases protection against oxidising agents, confers high elasticity upon the product with a view to subsequent forming and pressing operations, and also has film-forming properties such as to encourage subsequent application of the coating layer.

A transparent coating layer is applied onto the anticorrosion layer through a roller painting head with a yield of approximately 350 m²/kg·μm in the form of a polyester resin-based paint which can be dried in a stove at a temperature of approximately 400° C. The paint used has a dry residue of 42.5% by weight and a Ford 4 cup viscosity of 120″.

The painted strip then enters a drying stove, the temperature of which is adjusted so as to produce a peak metal temperature of between 220 and 240° C., after which it is rewound. This stage in the process takes place continuously at a speed varying from 25 to 60 metres per minute depending upon the characteristics of the equipment used. The paint layer has a final thickness of 7 μm.

Finally, where the rolled product has to be supplied as sheets, it is subjected to longitudinal and/or transverse cutting in the conventional way according to specific requirements.

The characteristics of the finished product are as follows:

| | | |
|---|---|---|
| Thickness | 0.50 | mm |
| Width | 980 | mm |
| Overall thickness of the anticorrosion and | 9 | μm |
| coating layers (ECCA T-1) | | |
| Surface appearance (ECCA T-2) | 80 | gloss |

| | |
|---|---|
| T-bend adhesion (ECCA T-7) | OT |
| Pencil hardness (ECCA T-4) | H |

Of course the details of embodiments and the manner of implementation may be varied extensively with respect to what has been described purely by way of example, while the principle of the invention remains unchanged, without thereby going beyond its scope. In particular the rolled product according to the invention may be directly manufactured in a batch way in the form of sheets in addition to in the form of a continuous strip which may be cut at the end of its production process.

1. Rolled product comprising a base layer of steel having a carbon content of between 0.10 and 0.20% and chromium- and/or tin-plated on both surfaces, an anticorrosion layer applied to at least one of the surfaces of the base layer and a transparent layer coating the anticorrosion layer, the said coating layer comprising a paint of the polyester and/or polyurethane and/or acrylic type.

2. Rolled product according to claim 1, in which the chromium plating on each surface of the base layer comprises a first sublayer of metal chromium with an average mass of between 50 and 150 mg/m² and a second sublayer of chromium oxide with an average mass of between 7 and 35 mg/m².

3. Rolled product according to claim 1, in which the layer of tin plating on each surface of the base layer has a mass per unit surface area of between 1 and 11.2 g/m².

4. Rolled product according to claim 3, in which the values for mass per unit surface area of the layer of tin plating on each surface of the base layer are the same or different.

5. Rolled product according to any of the preceding claims, in which the said base layer has a thickness of between 0.30 and 0.60 mm.

6. Rolled product according to any of the preceding claims, in which the said anticorrosion layer has a thickness of between 1 and 2 μm.

7. Rolled product according to any of the preceding claims, in which the said coating layer has a thickness of between 7 and 10 μm.

8. Rolled product according to any of the preceding claims, in which the said base layer is of steel having a carbon content of approximately 0.13%.

9. Rolled product according to any of the preceding claims, also comprising a film of PET applied to the outer surface of the coating layer.

10. Process for the production of a rolled product according to any of the preceding claims, comprising the stages of:
mechanically brushing a strip of chromium- and/or tin-plated steel,
applying an anticorrosion layer having film-forming properties to at least one surface of the strip of chromium- and/or tin-plated steel and then applying a transparent coating layer comprising a paint of the polyester and/or polyurethane and/or acrylic type, and
drying the anticorrosion layer and the paint.

11. Process according to claim 10, in which the said brushing is performed through the use of rotating and vibrating brushes made of aluminium oxide or silicon dioxide.
